(19) United States
(12) Patent Application Publication
(10) Pub. No.: US 2004/0117434 A1
(43) Pub. Date: Jun. 17, 2004

(54) System and method for merging, filtering and rating peer-solicited information

(76) Inventors: David F. Bantz, Bedford Hills, NY (US); Chatschik Bisdikian, Chappaqua, NY (US); Steven J. Mastrianni, Unionville, CT (US)

Correspondence Address: David Aker, 23 Southern Road, Hartsdale, NY, 10530, US

(21) Appl. No.: 10/317,624

(22) Filed: Dec. 12, 2002

(51) Int. Cl. G06F 15/16

(52) U.S. Cl. 709/201

(57) ABSTRACT

This invention provides a method, apparatus and computer product that enables sending a query to other computers on a network for information relevant to the location of the computer; receiving, in response to said query, from said other computers on the network said information; processing the information in accordance with predetermined policy criteria; and storing information which meets said criteria for later use. While very useful for the processing of bookmarks relevant to a specific geographic location of the computer, other information may include e-mail addresses, configuration parameters, computer programs, computer resource address, store addresses, and emergency contact information.

### FIELD OF THE INVENTION

This invention relates to networked computer systems. More particularly, it relates to computer systems, a method of operating such systems, and an article of manufacture having computer readable code to enable a computer to share information with other computers on a network.

### BACKGROUND OF THE INVENTION

In mobile personal computing, it is often the case that the user of a mobile notebook or hand held computer is present in a location and environment that is unfamiliar to him or her. The user may be unfamiliar with the communications networks that are available at that location, the variable parameters needed to access those communications networks or those that they connect to, the physical layout in the immediate vicinity, IT resources (e.g., printers) in the immediate vicinity or the location of important services (e.g., food, stores) that are nearby. This unfamiliarity may cause the user personal stress, loss of productivity or in the case of emergency services, undue risk to life and limb.

The most common means by which this unfamiliarity is dispelled is through interpersonal interaction with people knowledgeable about the immediate vicinity. Few locations offer a computer-accessible database of vicinity-specific information, and in those that do, the information in the database may not be current or complete. This is because people familiar with the vicinity often do the maintenance of that information, and those people have little motivation to keep that information complete and up-to-date. But it is often the case that people knowledgeable about a certain location keep information about that location and its immediate vicinity on their personal computers. For example, people keep information relevant to the communications networks available in a vicinity and the variable parameters needed to access those communications networks, because they need this information to access these networks. Accordingly, this information is kept complete and fresh.

Were it possible to interrogate the personal computers that belong to people knowledgeable about a certain vicinity for information relevant to the needs of people and computers in that vicinity, in an unobtrusive and efficient manner, and to aggregate, filter and prioritize this information for the visitor, this would materially assist the visitor in becoming familiar with the vicinity more quickly, especially in the case where interpersonal interaction with people knowledgeable of the vicinity is not immediately possible.

A paper “PowerBookmarks: A System for Personalizable Web Information Organization, Sharing and Management,” written by Wen-Syan Li, Quoc Vu, Divakant Agrawal, Yoshinori Hara and Hajime Takano discloses a system for collecting bookmarks when the user accesses a Web page and use of a proxy server for collecting information about bookmarks when a user accesses a Web page. PowerBookmarks keeps bookmark metadata on a centralized database called “WebDB.” That database is searchable by users.

U.S. Pat. No. 6,100,890 to Bates et. al. discloses methods for the automatic creation of bookmarks while browsing.

### SUMMARY OF THE INVENTION

This invention is, in general, directed to at least one of the query, retrieval, aggregation, merging, filtering and prioritization of existing bookmarks and other potentially location-specific information.

The invention disclosed herein implements automatic query, retrieval, aggregation, merging, filtering and prioritization of information resident in the personal computers that reside in or near a specific location. Although the invention will be described as if the visitor's personal computer must physically be in the specific location to acquire this information, this is not an inherent limitation of the invention, as will be described.

The value of this invention to the end user is faster accommodation to unfamiliar circumstances through acquisition of fresh, relevant information about the location and its immediate surroundings. This faster accommodation helps the user become productive quicker, reduces stress and may, in the case of knowledge about emergency services, prevent or ameliorate personal injury. Thus, this invention does not need to rely on a centralized database, because, in general, it concerns only localized information (e.g., bookmarks) and because it can be used to prioritize localized information without reference to content.

The invention includes software that runs on a personal computer. The software uses other software to communicate with other personal computers, that software implementing a “peer framework.” A peer framework is software that discovers, queries, identifies and responds to other personal computers also running the same peer framework. Peer frameworks may also implement security-related and privacy-protecting functions. The software of the invention uses the peer framework to generate a query confined to a specific subnet. A subnet is a portion of a computer communications network that does not include communications through a router. The topic of subnets is treated at length in chapter 16, sections 16.6 onward, of the book Internetworking with TCP/IP, volume I, by Douglas E. Comer, published in 1991 by Prentice-Hall. The property of subnets that is of interest here is that they are virtually always geographically local. That is, computers attached to a subnet are virtually always geographically proximate. The software of the invention queries other personal computers on a subnet. Only those personal computers running the software of the invention will respond, and they respond according to the query. The responses are captured and aggregated on the computer that originated the query. Aggregated responses are then analyzed to eliminate duplicates and create aggregated metadata. A rating module then assigns ratings and sorts the responses. Optionally, a user interface displays the sorted responses so that the user can select or reject specific responses. Finally, the responses are formatted in accordance with the needs of the specific data target and written to that target.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 is a block diagram of a computer system using the invention;

FIG. 2 is a software component block diagram of the invention;

FIG. 3 is a typical user dialog screen in accordance with the invention;

FIG. 4 is a flowchart associated with the user dialog screen of FIG. 3;

FIG. 5 is a flow chart of block 29 of FIG. 2;

FIG. 6 is a rating table in accordance with the invention; and

FIG. 7 is a flow chart of block 36 of FIG. 2.

### DESCRIPTION OF THE INVENTION

A preferred embodiment of the invention consisting of a description of the method and apparatus which may be employed will now be described.

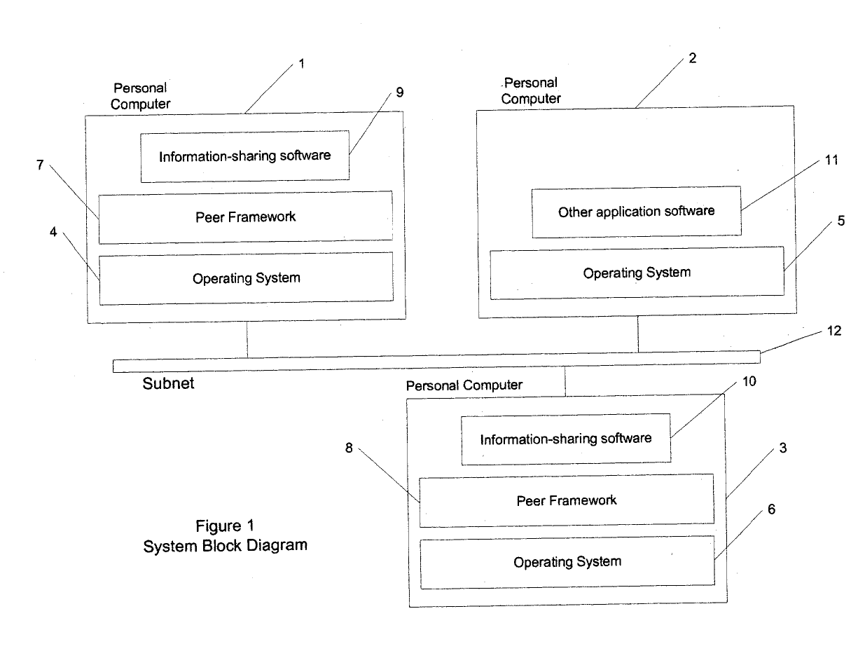

FIG. 1 shows an overall block diagram of a system including the software of the invention, hereafter referred to as the “information-sharing software.” In FIG. 1 are shown personal computers 1, 2 and 3. Each personal computer runs an operating system. For example, personal computer 1 runs operating system 4. Personal computer 2 runs applications software 11 using the functions and facilities of operating system 5. It can be seen from the FIG. 1 that personal computers 1 and 3 both run software 7 and 8 of the peer framework. An example of a peer framework is JXTA, available from www.jxta.org. The absence of any peer framework in personal computer 2 disables it from participating in information sharing as disclosed in this invention.

In FIG. 1, personal computers 1, 2 and 3 are connected to a common subnet 12. The peer framework software, instances of which are shown as 7 in personal computer 1 and 8 in personal computer 3 implements local query operations confined to subnet 12, so that queries for information remain geographically local.

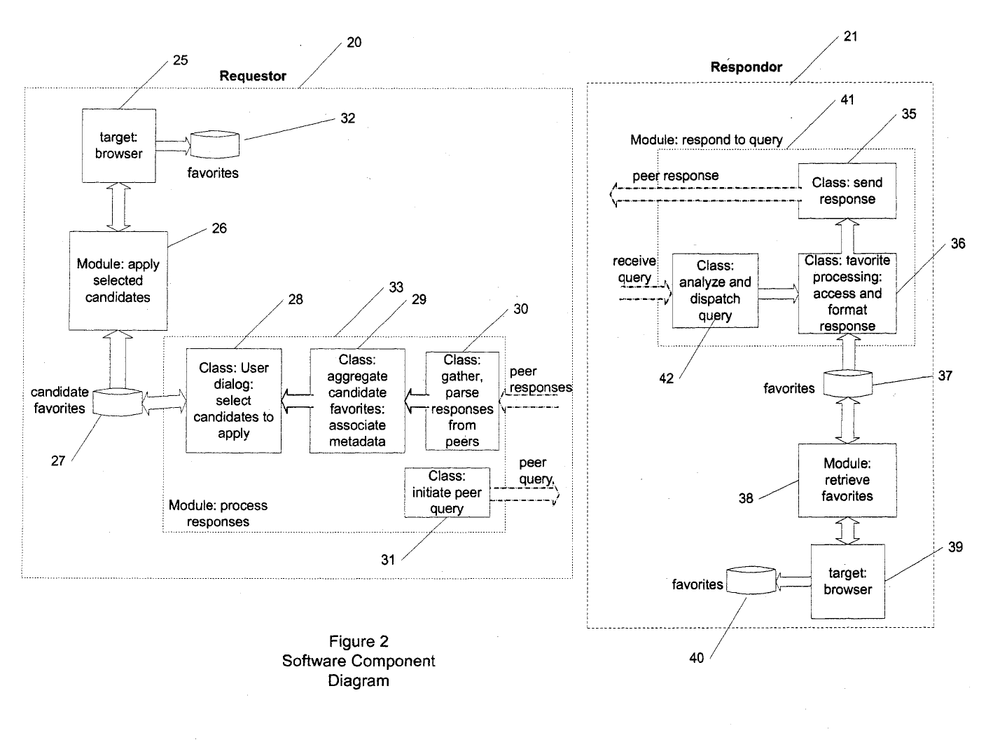

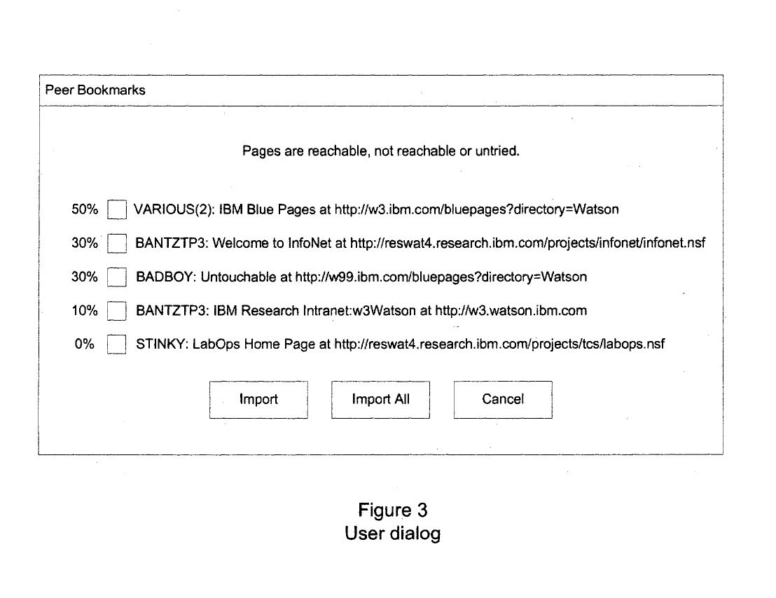

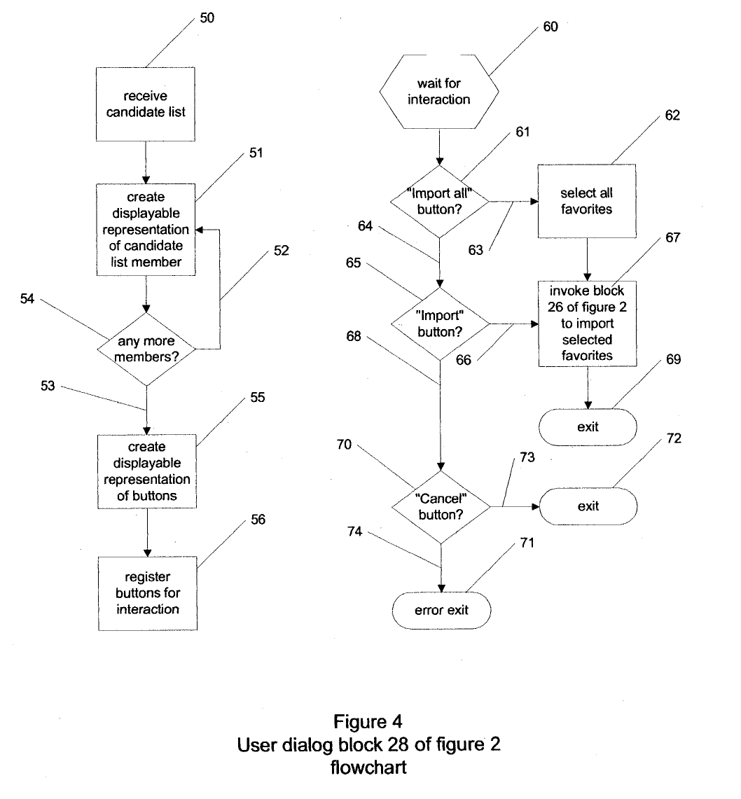

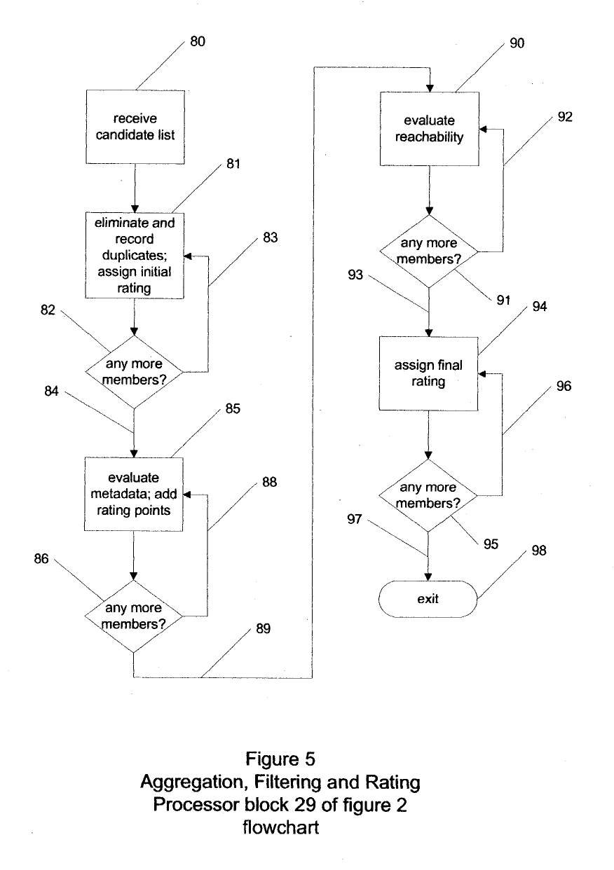

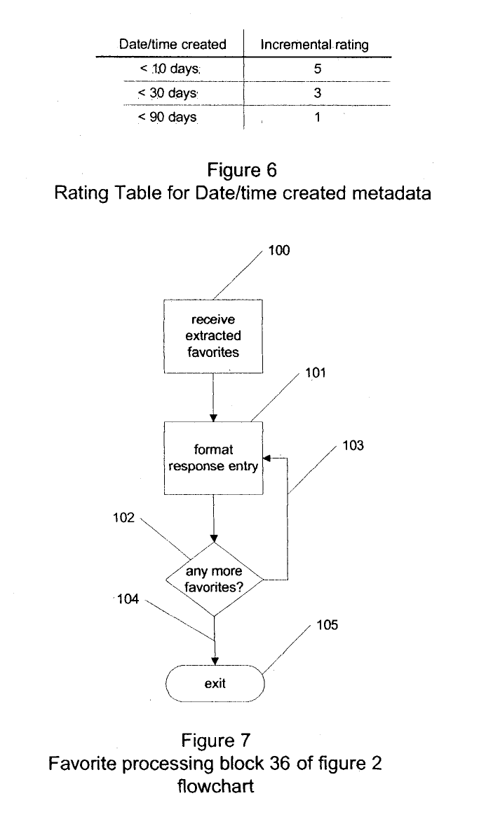

FIG. 2 depicts, in some detail, the flow of data between software components of the information-sharing software. Information-sharing software is shown as blocks 9 and 10 in FIG. 1. This software has two major functions: that of the requester 20 and that of the responder 21. Both functions are implemented in every instance of the information-sharing software. The requester functions are typically exercised by a personal computer whose user wishes to acquire location-specific knowledge; the responder functions are typically exercised by a personal computer whose user is willing to share location-specific knowledge with others.

In FIG. 2, requester 20 consists of query initiator 31. response processor 33, and export module and candidate application block 26. Upon activation of the software, query initiator 31 formats and transmits a query to other personal computers on the same subnet using the facilities of the peer framework. The software may be activated when the end user first boots the operating system on his or her personal computer, when the personal computer detects a change in location by whatever means, or at the direct command of the end user.

Responses to the query arrive at the response processor 33 using the facilities of the peer framework. These responses are gathered by a response gatherer 30 that is also responsible for creating an internal representation of the responses in a form convenient for further processing. This internal representation is then passed to an aggregation, filtering and rating processor 29 that eliminates duplicate responses and uses metadata supplied in the responses to form a prioritization of the various responses. This is represented as a modified form of the internal representation received by aggregation, filtering and rating processor 29. This modified internal representation is then optionally supplied to user interface dialog block 28 that optionally permits the end user to select and reject responses. The result of this is a candidate favorites list 27. The import of this candidate favorites list 27 into other software components of the personal computer is done by the candidate application block 26 that, for example, uses the import favorites capability of browser 25 to update its favorite list 32. An exemplary browser supporting the import favorites capability is Microsoft Internet Explorer 6.0.

Note that although this process has been described with respect to the acquisition of favorites into an existing browser, the process is fully general and can be applied to other location-specific information and to other software components.

In FIG. 2. respondor 21 is responsible for receiving queries from requestor 20, locating information to share, and generating a response to requester 20. Queries are received and responses are generated by response block 41. Query analysis block 42 receives the query and determines its type. Based on the type, block 42 selects a subsequent processing block. In FIG. 2, the selected subsequent processing block is favorite processing block 36. Favorite processing block 36 invokes retrieve favorites block 38 that, in turn, uses the export favorites capability of browser 39, which reads its favorites from favorites list 40. An exemplary browser supporting the export favorites capability is Microsoft Internet Explorer 6.0. Extracted favorites list 37 is obtained from retrieve favorites block 38. When favorites are retrieved from browser 39, parameters may be supplied to limit the extracted favorites to those residing in a dedicated folder, that folder containing favorites that the user of the personal computer running responder 21 wishes to share with visitors.

Extracted favorites 37 contain, typically, both data and metadata. The data of a favorite consists of a Uniform Resource Locator (URL) and the title of the Web page referenced by the URL. URLs are described in RFC 1738, available from www.w3.org. The metadata of a favorite consists of the dates and times at which the favorite was created, last referenced and last maintained. Favorite processing block 36 reads each favorite and creates a formatted response message. That message is passed to send response block 35 that uses the facilities of the peer framework to send the response.

It will be appreciated that although not shown in FIG. 2, an optional block containing a user interface dialog could be inserted in the data flow between extracted favorites 37 and favorite processing block 36. This optional block would alert the user of the personal computer running responder 21 that a query had been received soliciting favorites, and would enable the user to block the sharing of favorites that the user does not wish to share.

Returning to FIG. 2, the function of selected blocks 28, 29, 30, 31, 35, 36 and 42 in FIG. 2 will now be described in detail. Other blocks 25 and 39 represent existing software serving only to import or export favorites. Blocks 26 and 38 serve only to interface between a list of favorites and existing import/export facilities, and their internal function will be obvious to those skilled in the art.

FIG. 3 depicts the user dialog created by user dialog block 28 in FIG. 2. It can be seen from this image that various favorites are listed in order of rating, the topmost having the highest rating (50%). Each favorite is accompanied with a check box so that the user can select that favorite for import. A button, labeled “Import all,” is provided that automatically selects them all. Once the end user has selected favorites for import, the button “Import” initiates the import process previously described.

FIG. 4 depicts the internal function of user dialog block 28 of FIG. 2. In block 50 the user dialog block is invoked and receives the list of favorites from block 29 of FIG. 2. Block 51 converts the data of a favorite into a displayable representation. One software facility capable of this conversion is the “Java Foundation Classes Swing” component of the Java programming environment. For additional information on Swing, see The JFC Swing Tutorial, K. Walrath and M. Campione, Addison-Wesley 1999. The specific component of Swing that is most useful in this application is the JCheckBox. Blocks 51 and 54 form an iteration loop, wherein block 54 checks to see if the favorite list contains any entries that have not yet been converted into a displayable representation by block 51. If more remain, branch 52 is taken. If no more remain, branch 53 is taken. Block 55 then creates a displayable representation of the buttons of FIG. 3. A suitable Swing component is the JButton component. Finally, block 56 registers these buttons with the Java runtime environment so that when the user interacts with these buttons, other program components can be activated.

Block 60 and subsequent portions of the flowchart represent the other program components to be activated when the user interacts with any of the buttons. Block 61 checks to see if the interactive component was the “Import all” button and if so, branch 63 is taken to block 62, which marks all favorites as selected. A favorite can also be selected by the user clicking on a checkbook associated with that favorite, as can be seen in FIG. 3. If the interactive component was not the “Import all” button, branch 64 is taken. Block 65 then checks to see if the “Import” button was pressed. If so, branch 66 is taken to block 67, which then invokes block 26 of FIG. 2 to import all of the selected favorites. This block is also entered subsequent to the processing of block 62. After all of the selected favorites have been imported, exit 69 is taken.

If neither the “Import all” nor the “Import” button was pressed, branch 68 is taken to block 70, where the “Cancel” button is checked. If the “Cancel” button was pressed branch 73 is taken to exit block 72. If the “Cancel” button was not pressed, branch 74 is taken to error exit 71.

FIG. 5 details the function of block 29 of FIG. 2. This block automatically aggregates responses, eliminating duplicates and assigning ratings to favorites based on their duplication, metadata and reachability. Block 80 receives the multiple responses from block 30 of FIG. 2. Blocks 81 and 82 scan the list of responses, searching for duplicates. One method of such scanning is to remove the first member of the list of responses and add it to a temporary list, assigning it an initial rating of zero. Then, a check is conducted to see if the second member of the list of responses duplicates any entry in the temporary list. If it does, that fact is recorded in metadata associated with the duplicated entry in the temporary list, a specified amount is added to its rating, and the second member of the list of responses is discarded. If it does not, the second member of the list of responses is added to the temporary list, it is assigned an initial rating of zero, and it is deleted from the list of responses. Proceeding in this manner, all duplicates can be detected, recorded and eliminated. For each member except the last, branch 83 will be taken. Branch 84 is taken when the list of responses has been exhausted.

Blocks 85 and 86 evaluate the metadata of each entry in the temporary list in turn. For each entry except the last, branch 88 will be taken. For the last entry, branch 89 will be taken. In the specific case of the evaluation of the metadata of favorites, additional rating points are assigned according to a rating table. FIG. 6 depicts a typical rating table. The table is used by comparing the date/time created metadata with the first row of the first column of the table. In this specific case, the comparison is between the date and time the favorite was created, and the current date and time. If the creation date and time was less than 10 days ago, the favorite is assigned 5 additional rating points. If less than 30 days ago but more than 10 days ago, the favorite is assigned 3 additional rating points. If less than 90 days ago but more than 30 days ago, the favorite is assigned just one additional rating point.

It can be appreciated that other means exist to score a favorite by means of its metadata, and that the approach described here is illustrative of one means but does not limit the invention to this means alone.

Returning to FIG. 5, blocks 90 and 91 evaluate whether each favorite can be reached. This can be accomplished by a method invocation on the Java class “URL,” for example; that is simply checking to see if a site still responds. For each favorite except the last, branch 92 is taken. After the last favorite is evaluated in block 90, block 91 will take branch 93.

Blocks 94 and 95 assign a final rating to each favorite. For each favorite except the last, branch 96 will be taken. After the final rating is assigned to the last favorite, block 95 will take branch 97 to exit block 98. Processing in block 94 can include, but is not limited to, adding additional rating points to a favorite according to how many times it was duplicated and limiting the maximum rating value to 100.

Block 30 of FIG. 2 receives responses from the peer framework, and with knowledge of the format of responses, generally creates an internal representation of responses that will be supplied to block 29 for aggregation, filtering and rating processing. A preferred implementation of responses is that they are sent using an XML representation, structured according to a predefined XML schema known to all personal computers running the information-sharing software. XML and XML schemas are described in Java and XML, B. McLaughlin, O'Reilly & Associates, 2000. Parsing and validation of XML according to a predefined schema is well-known in the art and may be performed by the XML Parser for Java, for example, available for download from http://www.alphaworks.ibm.com/. The implementation of block 30 of FIG. 2 is apparent to those skilled in the art, given knowledge of an XML parser and a peer framework.

Similarly, block 31 of FIG. 2 creates a query to be sent using the facilities of the peer framework. The preferred format of this query is an XML representation, structured according to a predefined XML schema. The implementation of block 31 of FIG. 2 is apparent to those skilled in the art, given knowledge of XML and a peer framework.

Block 42 of FIG. 2 receives a query using the facilities of the peer framework. The preferred format of this query is an XML representation, structured according to a predefined XML schema. Block 42 parses the query and uses the results of the parse to classify the query type. This can be performed by a comparison of a field value in the incoming query with predefined values in the schema. If the match indicates that the incoming query is for favorite processing, block 36 will be executed next. If the match is not for favorite processing, some other block will be executed, and if there is no match the query will be rejected as erroneous. The implementation of block 31 of FIG. 2 is apparent to those skilled in the art, given knowledge of an XML parser and a peer framework.

A flowchart of the implementation of block 36 of FIG. 2 is given in FIG. 7. In block 100 of FIG. 7 the extracted favorites are received from block 38 of FIG. 2. Blocks 101 and 102 process each favorite into response entries, preferably encoded as XML according to a predefined schema. The XML representation of a favorite would include, for example, the value of its Uniform Resource Locator, or URL; the title of the page for which this is the favorite, and all of the metadata maintained by the browser for this favorite. For all favorites except the last, branch 103 will be taken. Subsequent to the creation of a response entry for the last favorite, branch 104 will be taken to exit 105.

Block 35 of FIG. 2 creates a response to be sent using the facilities of the peer framework. The preferred format of this response is an XML representation, structured according to a predefined XML schema. The implementation of block 35 of FIG. 2 is apparent to those skilled in the art, given knowledge of XML and a peer framework.

It can be seen that the description given above provides a simple, but complete implementation of automatic query, retrieval, aggregation, merging, filtering and prioritization of information resident in the personal computers that reside in or near a specific location. The description given is exemplary of one type of information, that being favorites. The extension of this implementation to other types of information is obvious, and includes information-specific processing such as validation and message formatting. Rating may also be information-specific and may include such factors as a history, maintained by information source, of whether the information obtained from that source was accurate, current and valuable. Information may also be evaluated based on joint factors. For example, if an item of information was received from one source and also from another, and if the metadata was inconsistent between the two items, a low or zero rating may be assigned. Since the step of interacting with the end user before importing information is optional, means to make automatic decisions about what information to import and what to reject are also the subject of this invention. Such means include but are not limited to a threshold value for the rating of each item of information, such that if the rating of a particular piece of information is below the threshold it will not be imported.

Although the invention has been described using means of limiting queries to personal computers on a given subnet, other means can be employed to ensure that only information that is geographically local is obtained. These means include but are not limited to personal computers belonging to a given organisation, or personal computers with independent means of determining their location, such as the Global Positioning System (GPS), having geographic co-ordinates within a certain range. The GPS co-ordinates may be communicated to other computers on the network, by for example using the network, including sending the co-ordinates along with the information sent in response to a query, or not responding if more than a predetermined distance from a computer sending its GPS co-ordinates with an inquiry. Personal computers connected wirelessly via Personal Area Wireless Network Technology (e.g., Bluetooth and infrared) or Local Area Wireless Network Technology (e.g. 802.11a or b) are, of necessity, geographically proximate because the range of these wireless links is limited.

Variations described for the present invention can be realized in any combination desirable for each particular application. Thus particular limitations, and/or embodiment enhancements described herein, which may have particular advantages to the particular application need not be used for all applications. Also, it should be realized that not all limitations need be implemented in methods, systems and/or apparatus including one or more concepts of the present invention.

The present invention can be realized in hardware, software, or a combination of hardware and software. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods. Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments has been provided as an example and not as a limitation. The scope of the invention is defined by the appended claims.

Having thus described our invention, what we claim as new and desire to secure by Letters Patent is as follows:

1. A method for operating a computer on a network, comprising:
sending a query to other computers on the network for information relevant to the location of the computer;
receiving, in response to said query, from said other computers on the network said information;
processing the information in accordance with predetermined policy criteria; and
storing information which meets said criteria for later use.

2. The method as recited in claim 1, wherein the information comprises at least one of bookmarks, e-mail addresses, configuration parameters, computer programs, computer resource address, store addresses, and emergency contact information.

3. The method as recited in claim 1, wherein the information is specific to the geographic location of said computer.

4. The method as recited in claim 3, wherein the information is obtained only from computers within a specific range of geographic locations.

5. The method of claim 4, further comprising defining said range of geographic locations using GPS co-ordinates of said other computers.

6. The method as recited in claim 1, further comprising evaluating the information in accordance with metadata associated with each item of information.

7. The method as recited in claim 6, wherein said metadata includes at least one of date the information was created, date the information was last updated, date the information was last accessed, a node name of the computer supplying the information, prior rating of items of information from that node, whether or not the information can be accessed, and a portion of the information.

8. The method as recited in claim 5, wherein the information comprises bookmarks, and the bookmarks are rated, and wherein only bookmarks having at least a predetermined rating are stored for future use.

9. The method as recited in claim 8, wherein said rating is increased if a bookmark has a source that is reputable, has been recently accessed, and has been received from multiple sources.

10. The method as recited in claim 1, further comprising rating the information, wherein only information having at least a predetermined rating is stored for future use.

11. The method as recited in claim 10, wherein said rating is increased if the information has a source that is reputable, has been recently accessed, and has been received from multiple sources.

12. The method as recited in claim 10, wherein the rating further comprises consulting a rating table to provide an incremental rating, said incremental rating being based on how recently an item of information was accessed.

13. The method as recited in claim 1, wherein the processing comprises at least one of rating, aggregating and publishing the data.

14. The method as recited in claim 1, further comprising displaying a user dialog to a user of the computer, said user dialog having options for the user to import all data from other computers, selected data from other computers, and to cancel importation of data.

15. The method as recited in claim 1, wherein said processing further comprises eliminating duplicate information.

16. The method as recited in claim 1, wherein the network is defined at least in part by wireless connections.

17. The method as recited in claim 16, wherein the wireless connections are at least one of an infrared link and a radio frequency link.

18. A computer system for sharing information between computers on a network, said system comprising:
a portion for sending a query to other computers on the network for information relevant to the location of the computer;
a portion for receiving, in response to said query, from said other computers on the network said information;
a processor for processing the information in accordance with predetermined policy criteria; and
a memory for storing information which meets said criteria.

19. The system as recited in claim 18, wherein the information comprises at least one of bookmarks, e-mail addresses, configuration parameters, computer programs, computer resource address, store addresses, and emergency contact information.

20. The system as recited in claim 18, wherein the information is specific to the geographic location of said computer.

21. The system as recited in claim 20, configured so that the information is obtained only from computers within a specific range of geographic locations.

22. The system of claim 21, further comprising means for defining said range of geographic locations using GPS co-ordinates of said other computers.

23. The system as recited in claim 18, further comprising a processor for evaluating the information in accordance with metadata associated with each item of information.

24. The system as recited in claim 23, wherein said metadata includes at least one of date the information was created, date the information was last updated, date the information was last accessed, a node name of the computer supplying the information, prior rating of items of information from that node, whether or not the information can be accessed, and a portion of the information.

25. The system as recited in claim 24, wherein the information comprises bookmarks, and the bookmarks are rated, and wherein only bookmarks having at least a predetermined rating are stored for future use.

26. The system as recited in claim 25, wherein said rating is increased if a bookmark has a source that is reputable, has been recently accessed, and has been received from multiple sources.

27. The system as recited in claim 18, further comprising a processor for rating the information, wherein only information having at least a predetermined rating is stored for future use.

28. The system as recited in claim 27, wherein said rating is increased if the information has a source that is reputable, has been recently accessed, and has been received from multiple sources.

29. The system as recited in claim 27, further comprising a rating table which is consulted to provide an incremental rating, said incremental rating being based on how recently an item of information was accessed.

30. The system as recited in claim 18, comprising a processor for performing at least one of rating, aggregating and publishing the data.

31. The system as recited in claim 18, further comprising a display for displaying a user dialog to a user of the computer, said user dialog having options for the user to import all data from other computers, selected data from other computers, and to cancel importation of data.

32. The system as recited in claim 18, comprising a processor for eliminating duplicate information.

33. The system as recited in claim 18, wherein the network is defined at least in part by wireless connections.

34. The system as recited in claim 33, wherein the wireless connections are at least one of an infrared link and a radio frequency link.

35. An article of manufacture comprising a computer usable medium having computer readable program code embodied therein for causing a computer on a network to perform steps of:
sending a query to other computers on the network for information relevant to the location of the computer;
receiving from other computers on the network said information;
processing the information in accordance with predetermined policy criteria; and
storing information which meets said criteria for later use.

36. The article of manufacture as recited in claim 35, wherein the information comprises at least one of bookmarks, e-mail addresses, configuration parameters, computer programs, computer resource address, store addresses, and emergency contact information.

37. The article of manufacture as recited in claim 35, wherein the information is specific to the geographic location of said computer.

38. The article of manufacture as recited in claim 37, wherein the information is obtained only from computers within a specific range of geographic locations.

39. The article of manufacture of claim 38, further comprising defining said range of geographic locations using GPS co-ordinates of said other computers.

40. The article of manufacture as recited in claim 35, further comprising computer readable program code embodied therein for causing the computer to evaluate the information in accordance with metadata associated with each item of information.

41. The article of manufacture as recited in claim 40, wherein said metadata includes at least one of date the information was created, date the information was last updated, date the information was last accessed, a node name of the computer supplying the information, prior rating of items of information from that node, whether or not the information can be accessed, and a portion of the information.

42. The article of manufacture as recited in claim 39, wherein the information comprises bookmarks, and the bookmarks are rated, and wherein only bookmarks having at least a predetermined rating are stored for future use.

43. The article of manufacture as recited in claim 42, further comprising computer readable program code embodied therein for causing the computer to increased said rating if a bookmark has a source that is reputable, has been recently accessed, and has been received from multiple sources.

44. The article of manufacture as recited in claim 35, further comprising computer readable program code embodied therein for causing the computer to rate the information, wherein only information having at least a predetermined rating is stored for future use.

45. The article of manufacture as recited in claim 44, wherein said computer readable program code increases said rating if the information has a source that is reputable, has been recently accessed, and has been received from multiple sources.

46. The article of manufacture as recited in claim 44, wherein the rating further comprises computer readable program code embodied therein for causing the computer to consult a rating table to provide an incremental rating, said incremental rating being based on how recently an item of information was accessed.

47. The article of manufacture as recited in claim 35, comprising a processor for performing at least one of rating, aggregating and publishing the data.

48. The article of manufacture as recited in claim 35, further comprising computer readable program code embodied therein for causing a display associated with the computer to display a user dialog to a user of the computer, said user dialog having options for the user to import all data from other computers, selected data from other computers, and to cancel importation of data.

49. The article of manufacture as recited in claim 35, wherein said processor further eliminates duplicate, information.
